(19) United States
(12) Patent Application Publication
(10) Pub. No.: US 2026/0317126 A1
(43) Pub. Date: Oct. 15, 2026

(54) ELEVATOR SYSTEM WITH MOVABLY ATTACHED GUIDE SHOES TO UPRIGHTS OF AN ELEVATOR CAR

(71) Applicant: Otis Elevator Company, Farmington, CT (US)

(72) Inventors: Franck Rivoiret, Les bordes (FR); Aurelien Fauconnet, Isdes (FR)

(21) Appl. No.: 19/410,677

(22) Filed: Dec. 5, 2025

(30) Foreign Application Priority Data
Apr. 15, 2025 (EP) 25305545.3

(51) Int. Cl. B66B 7/04; B66B 11/00; B66B 11/02; B66B 11/04

(52) U.S. Cl. CPC B66B 7/048; B66B 7/047; B66B 11/0045; B66B 11/0206; B66B 11/043

(57) ABSTRACT

An elevator system (1) including at least one upright (3), with a guide shoe (5) being attached to the upright (3) for guiding of movement of an elevator car (2) along a guide rail (4), the guide shoe (5) is slideably connected to the upright (3) between an upper position and a lower position, whereby the guide shoe (5) is in the upper position when the elevator car (2) is in a first reduced travel length mode and whereby the guide shoe (5) is in the lower position when the elevator car (2) is in a second enlarged travel length mode, a displacement means (9) is attached to the guide shoe (5) for forcing the guide shoe (5) into the upper position.

### FOREIGN PRIORITY

This application claims priority to European Patent Application No. 25305545.3, filed Apr. 15, 2025, and all the benefits accruing therefrom under 35 U.S.C. § 119, the contents of which in its entirety are herein incorporated by reference.

### SUMMARY

The disclosure concerns an elevator system comprising at least one upright, i.e. a rail to be fixed to an elevator car, for movement along a guide rail which is stationary in a building. The upright shall comprise a guide shoe being attached to said upright for guiding movement of an elevator car- and consequently the attached upright-along the guide rail.

In this disclosure the term “machine” is used for a device comprising inter alia-an (electrical) motor, a brake and a traction sheave. Concerning this technical term it is worth noting, that a “drive” is controlling power supply to the motor. Further, generally a “car” is comprising—inter alia—a cab and a frame. The frame is comprising the uprights.

By a “guide shoe” a “car guidance element” is to be understood, not necessarily having a geometrical configuration like a shoe, though this may be preferable.

Elevator systems may be used to carry loads between landings of a building.

Elevator systems also include at least one elevator car, at least one counterweight, at least one machine,, so that the at least one elevator car can be moved in a longitudinal direction along a hoistway in a building along the guide rail(s).

During this up-or down-movement, normally an upper guide shoe, fixed to one upright, interacts with one guide rail to guide the movement of the elevator car. A lower guide shoe, also fixed to the (same) upright, interacts with the same guide rail also to guide the movement.

On each side of the elevator car, or rather more precisely the cab, there may be two parallel uprights, with an upper guide shoe and a lower guide shoe each. Consequently, identical or similar pairs of uprights, with respective upper and lower guide shoes, may be on opposite sides of the elevator car, or rather more precisely the cab.

The applicant is known for high performance elevator constructions. Those constructions are faster and allow more cost efficient building constructions. They have a better building roof isolation and perfectly fit in existing hoist spaces for lift replacement. Such high performance elevator constructions shall eliminate the need to perform any maintenance operation from the top of the car. Instead, maintenance from the inside of the elevator car shall become possible. No longer a refuge space at the top of the hoist place shall be necessary nor any “protrusion” on the roof of the building.

New standards for safety shall be achieved. Especially low pits and low overhead options are desirable. However, such new generation constructions induce very specific constraints on the system's layout.

On the one hand, modern generation constructions make in-car maintenance operations possible. On the other hand, they make it necessary to extend the car guide rail tracks above the machine bed plate, so that they extend into the overhead.

By doing so, the distance between the car guidance elements, such as guide shoes, has to be maximized. However, the designers are obliged also to place the guide rail between the machine, comprising the electrical motor, and a car frame of the elevator car, or rather more precisely of the cab. This has negative impact on the hoistway dimension and increases the costs, due to specific extra guide rails to be implemented, compared to the design known in the art.

It is the object of the disclosure to abolish or minimize the drawbacks in comparison to the state of the art.

This is achieved by said elevator system by ingeniously establishing a sliding connection (rather than a fixed connection as known in the art) of the guide shoe to the upright. The sliding connection allows sliding of the guide shoe between an upper position, which may also be called fully extended position, and a lower position, which may also be called retracted position, whereby the guide shoe is in the upper position when the elevator car is in a first (reduced) travel length mode, for example between the lowest floor and the penultimate floor, and whereby the guide shoe is in the lower position, when the elevator car is in the second (enlarged) travel length mode, for example between the penultimate and the ultimate floor/highest landing, whereas a displacement means is attached to the guide shoe for forcing the guide shoe into the upper position.

In other words, the idea behind the invention consists of having the upper car guidance able to move, i.e. slide, in the vertical direction between the first/upper position and the second/lower position.

The “fully extended” position, i.e. the first position, may be defined by the distance between the upper and lower car guidance elements, i.e. the upper guide shoe and the lower guide shoe, to be at a maximum. This position will be accessed when the elevator car is running between the lowest level and e.g. almost 500 mm below the uppermost landing. The “retracted” position, i.e. the second/lower position is defined by the distance between the upper and lower car guidance elements, i.e. the upper guide shoe and the lower guide shoe, to be at a minimum. This “retracted” position will be active only, when the elevator car will run from a point e.g. 500 mm below the uppermost/top landing to the uppermost/top landing position.

The upper car guidance element, i.e. the upper guide shoe, will move from “fully extended” to “retracted” position thanks to a stop located at the upper extremity of the car guide rail and/or the machine bedplate. The upper car guidance element, i.e. the upper guide shoe, will move from “retracted” to “fully extended” position thanks to a vertical spring. This vertical spring is an embodiment for the displacement means used for forcing the guide shoe into its upper position. The upper guide shoe therefore can be vertically extended to the higher position in comparison of said two extreme positions. Thus, the displacement means holds the guide shoe in the upper position. If the elevator car is moving in the area of 500 mm below the uppermost landing and the uppermost landing, the guide shoe is moved against the force of a displacement means, i.e. against the spring force, to its lower position. The guide shoe is moved to its lower position as a result of a mechanical contact between the machine bedplate and the guide shoe. This contact will come into existence only at low speed of the elevator car, as it is already slowing down for the highest landing arrival. Only at such low speed, the upper guide shoe is coming into mechanical contact with the bed plate, so that due to the continued slow movement of the car the upper guide shoe is moved to the lower position on the still moving upright.

The disclosure allows for the car guide rail not to have to be extended beyond the level of the machine bedplate, thus making it possible to move the machine closer to the car and increase the clearance between the tension member, such as a CSB (Coated Steal Belt), and CWT (counterweight) guide rail bracket and consequently reduce the hoistway width.

In other words, in designs known in the art the guide rails extend beyond (i.e. above) the machine bedplate. To accommodate the guide rails and the interacting upper guide shoes next to the machine bedplate and the machine, this necessitated a certain lateral distance from the cab and its attached upright(s). in embodiments of this invention, the guide rails can end below the machine bedplate and of course also the machine. By allowing this, the machine and the machine bedplate can come closer to the cab and the upright with the (upper) guide shoe.

By allowing the upper guide shoe to leave its normal “fully extended” position to its “retracted” (i.e. lower) position, a lateral guidance is still possible, even in those last few millimeters.

By allowing shorter guide rails and thereby making it possible to move the machine bedplate and machine closer to the cab the space in the hoistway can be better used, e.g. by having a more voluminous (i.e. bigger cross-sectioned) elevator car.

By reducing the necessary hoistway width, existing hoistways can be more efficiently used, for example by more voluminous elevator cars. In other words, by moving machine and machine bedplate closer to the car, it is possible to either use more voluminous elevator cars when keeping the hoistway width or leave the elevator car dimensions unchanged and reduce hoistway width, thereby gaining more space in the building for other purposes such as living. Of course, a combination of the two is possible as well.

The idea therefore allows improving the hoistway layout by minimizing the distance between the machine and the elevator car. Around 30 mm width is saved. In addition, the guide rails can be shorter, so that material costs are saved.

One embodiment is characterized in that the displacement means comprises a spring, whereas the spring is connected to the upright and to the guide shoe or a counter plate connected to the guide shoe. Alternatively, the displacement means comprises a weight and a pulley system attached to the guide shoe or the counter plate. The spring on the one hand and the weight and pulley system on the other hand are efficient means to force the guide shoe and possibly the counter plate fixedly connected to the guide shoe in the upper position. By allowing this forcing of the guide shoe and/or the counter plate in the upper position, the distance between said upper guide shoe and a lower guide shoe fixedly connected to an upright is maximized. This way, during most of the travel distance of the elevator car in the hoistway a maximum distance between upper and lower guide shoes will be achieved thereby providing maximum stability and improved ride quality. Only within the uppermost part of the travel distance, i.e. in the last centimeters or millimeters below the uppermost landing when the travel speed is already reduced because the elevator is close to the uppermost landing where it will have to stop, a retraction of the upper guide shoe (and, possibly, its counter plate) to the lower position is allowed. In this area, the travel speed is already reduced because the elevator car is close to the uppermost landing where it will have to stop anyhow. Therefore, there is only minimum, if any, negative impact on stability and ride quality.

If the spring is a compression spring or a pull spring, preferably a coil spring, the force by which the upper guide shoe and/or its counter plate is pushed/pulled in the upper position can be easily and reliably provided for a long time.

Preferably, the guide shoe is movably/slidably positioned in one slot or preferably a plurality of slots, where the slot or the slots is/are defining the upper position and the lower position at the respective ends of the slot(s) for the (upper) guide shoe. In such a configuration, preferably two slots can be provided parallel to each other, parallel to the vertical direction and preferably parallel to the longitudinal axis of the upright. In an embodiment, the distance from one slot to the edge of an upright may be identical for both slots.

The mountability of the different components is improved if the guide shoe is positioned on one side of the upright and a counter plate is positioned on the other side of the upright, whereas the guide shoe and the upright are connected to each other via connecting members extending through the slot(s). In addition, this improves stability of the elevator car.

Screws, bolts, and/or rivet nuts have proven to be efficient as connecting members.

An exemplary embodiment of the elevator system comprises at least one guide rail being in guiding contact with at least one guide shoe for guiding the movement of the elevator car during up- and/or down-mode-of-operation.

Logically it is of benefit if the elevator system comprises a machine with a motor, such as an electric motor, for hoisting the elevator car up or down. By such a motor, any kind of motor using any kind of power for hoisting or lowering the elevator car is to be understood, including electric power, hydraulic power or other power sources.

It is also of benefit, if the machine is connected to the at least one guide rail or more guide rails at a position upwards of the top end of (all) the guide rails.

According to another embodiment, the elevator car comprises a car frame to which at least two uprights are fixed, preferably parallel and pointing in the vertical direction.

To provide easy access to e.g. a spring-like displacement means the spring may be connected at one end to a lug of the upright.

All uprights may have the same or identical guide shoes and a comparable interconnection layout.

### DRAWING DESCRIPTION

In the following, exemplary embodiments of the disclosure are described in more detail with respect to the enclosed figures:

FIG. 1 depicts a schematic view of an elevator system according to an exemplary embodiment of the invention.

FIG. 2 depicts a schematic side view of an elevator car having four uprights, at least one upper guide shoe at each upright, whereas each of the upper guide shoes are in contact with a respective guide rail, whereas on top of a guide rail a machine with a machine bedplate is provided.

FIG. 3 is a perspective view of a first side of one of the uprights shown schematically in FIG. 2, whereas

FIG. 4 is a perspective view of the other side of the same upright, with the upper guide shoe being in the upper (i.e. fully extended) position.

FIG. 5 depicts the elevator car in the uppermost landing position or only a few millimeters below of it, so that the (upper) guide shoes are in their lower (i.e. retracted) position, whereas in FIG. 2 they are in their upper (i.e. fully extended) position.

FIGS. 6 and 7 show the same embodiment as in FIGS. 3 and 4, in which the upper guide shoe on the one side and a corresponding counter plate on the other side of the upright are interconnected to one another, whereas the upper guide shoe is in the lower (i.e. retracted) position, compressing the spring.

FIG. 8 is a different embodiment of the invention, in which the (upper) guide shoe is slidably held in a counter plate, which is fixed on the same side of the upright on which the (upper) guide shoe is slidably held.

FIG. 9 is an enlarged view of the area ix of FIG. 8.

FIG. 10 depicts a cross-sectional view through the upright, the counterplate and its connecting members as well as the (upper) guide shoe and a respective part of the guide rail, as far as depicted in FIG. 9 along the line X-X.

The figures are only schematical in nature and solely intended to simplify the understanding of the invention.

Similar features of the embodiment shown in any of the figures shall be numbered accordingly.

### DETAILED DESCRIPTION

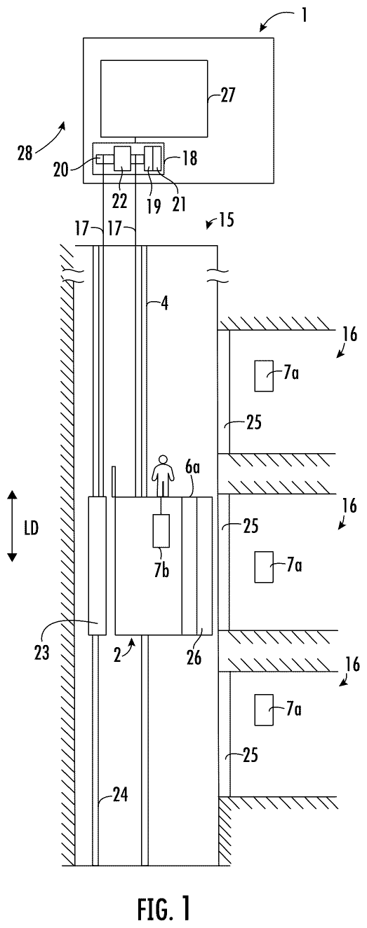

FIG. 1 schematically depicts an elevator system 1 according to an exemplary embodiment of the invention.

The elevator system 1 comprises a hoistway 15 extending along a longitudinal direction LD between a plurality of landings 16 located on different floors. The elevator system 1 includes an elevator car 2 that is arranged in the hoistway 15 and is moveable along the longitudinal direction LD between the plurality of landings 16. The elevator car 2 may in particular be movable along at least one elevator car guide rail 4 provided in the hoistway 15 and extending along the longitudinal direction LD.

The longitudinal direction LD may be oriented in a vertical direction, as it is depicted in FIG. 1. In an alternative embodiment, which is not depicted in the figures, the longitudinal direction LD may be inclined with respect to the vertical direction.

Although only a single elevator car guide rail 4 is depicted in FIG. 1, the elevator system 1 may comprise a plurality of elevator car guide rails 4 extending parallel to each other.

Although only a single elevator car 2 is depicted in FIG. 1, exemplary embodiments of the disclosure may also include elevator systems 1 comprising a plurality of elevator cars 2 moving in one or more hoistways 15.

The elevator car 2 is movably suspended by means of a tension member 17. Although only a single tension member 17 is depicted in FIG. 1, exemplary embodiments of the disclosure may also include elevator systems 1 comprising a plurality of tension members 17.

The at least one tension member 17, for example a rope or belt, is coupled to an elevator drive system 18. The elevator drive system 18 comprises a machine with a motor 19 for rotatably driving a shaft 20, and a drive 21 that harnesses and controls the electrical energy supplied to the motor 19. The elevator drive system 18 is configured for driving the at least one tension member 17, which is coupled to the shaft 20 via traction, in order to move the elevator car 2 in the hoistway 15 along the longitudinal direction LD between the plurality of landings 16.

The elevator drive system 18 is further provided with at least one elevator brake 22 for braking rotation of the shaft 20 in order to allow for stopping movement of the elevator car 2 and holding the elevator car 2 at a desired position in the hoistway 15.

Optionally, the elevator system 1 may comprise a counterweight 23. The counterweight 23 may be attached to the at least one tension member 17 opposite to the elevator car 2 and configured for moving concurrently and in opposite direction with respect to the elevator car 2. The counterweight 23 may move along at least one counterweight guide rail 24 provided in the hoistway 15 and extending along the longitudinal direction LD.

The at least one tension member 17 may be a rope, e.g. a steel cord, or a belt, in particular a coated steel belt. The at least one tension member 17 may be uncoated. Alternatively, the at least one tension member 17 may be coated with a coating, e.g. with a coating having the form of a polymer jacket. In a particular embodiment, the at least one tension member 17 may be a belt comprising a plurality of polymer coated steel cords (not shown). The elevator system 1 may have a traction drive including a traction sheave for driving the at least one tension member 17.

In the exemplary embodiment depicted in FIG. 1, a 1:1 roping is employed for suspending the elevator car 2. The type of the roping is, however, not essential for the disclosure and different kinds of roping, e.g. a 2:1 roping or a 4:1 roping may be employed as well.

A landing door 25 is provided at each of the landings 16. The elevator car 2 is provided with a corresponding elevator car door 26 for allowing passengers to transfer between a landing 16 and the interior of the elevator car 2, when the elevator car 2 is positioned at the respective landing 16.

For moving the elevator car 2 along the hoistway 15 between the different landings 16, the elevator drive system 18 may be controlled by an elevator controller 27 of the elevator system 1.

The elevator system 1 may be a machine room-less elevator system 1. In an alternative embodiment, the elevator system 1 may comprise a machine room 28 housing the elevator drive system 18 and the elevator controller 27.

Input to the elevator controller 27 may be provided via landing control panels 7a provided on every landing 16, in particular in the vicinity of the landing doors 25, and/or via an elevator car control panel 7b provided inside the elevator car 2.

The landing control panels 7a may comprise elevator hall call buttons and/or destination call buttons. Destination call buttons allow passengers to enter their respective destinations before entering the elevator car 2. In case the landing control panels 7a are equipped with destination call buttons, no elevator car control panel 7b needs to be provided inside the elevator car 2 since the elevator system 1 is fully controlled by the commands input via the landing control panels 7a.

The landing control panels 7a and the elevator car control panel 7b may be coupled with the elevator controller 27 by means of electrical wiring not shown in FIG. 1, in particular by an electric bus, or by wireless data connections.

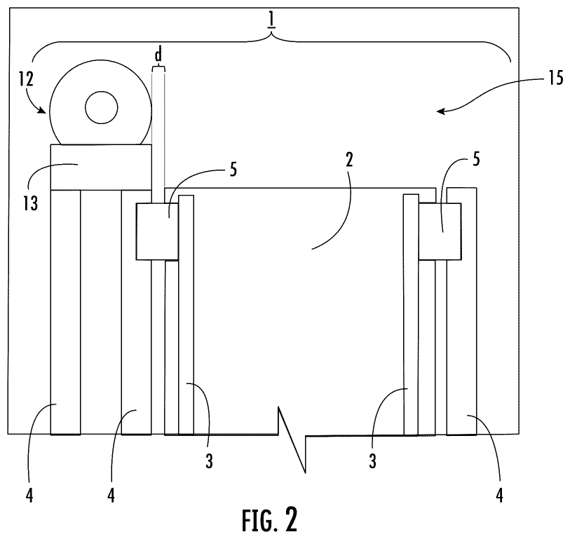

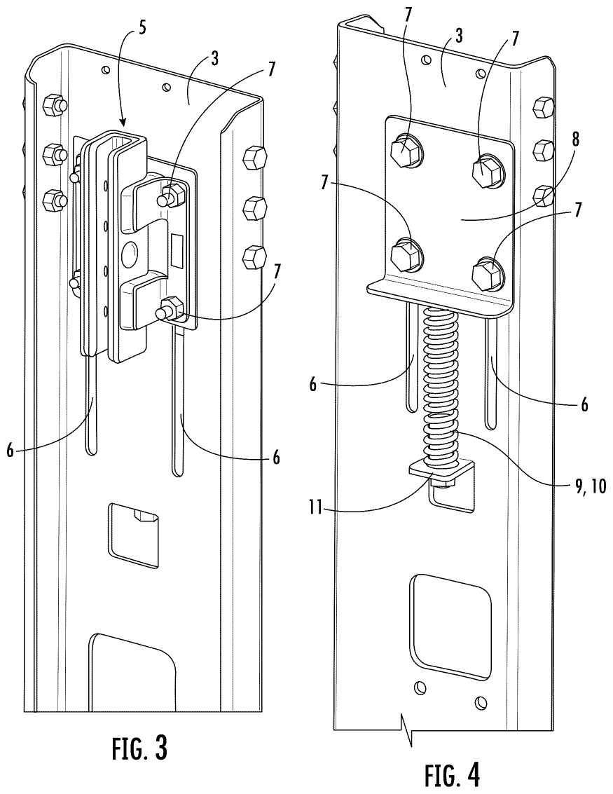

In FIG. 2 an elevator system 1 is positioned in a hoistway 15. In the hoistway 15 an elevator car 2 moves vertically, i.e. i.e. in an upward or downward direction.

As depicted in FIG. 2 at least two uprights 3, normally four uprights 3 are used. Two uprights 3 are on the outside of the elevator car 2 next to guide rails 4, whereas at least one (upper) guide shoe 5 is attached to an upper end of the upright 3.

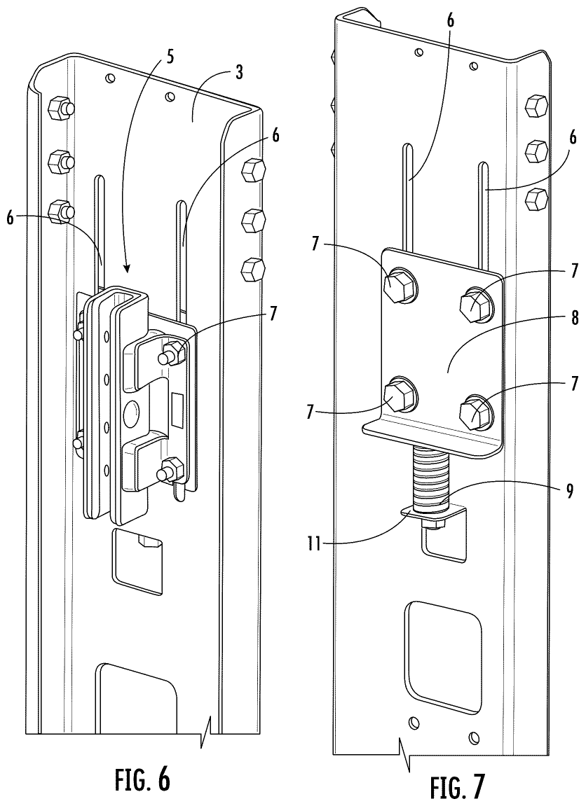

As can best be seen in FIGS. 3 and 6, the (upper) guide shoe 5 is slidably connected to the upright 3. Whereas in FIG. 3 the (upper) guide shoe 5 is in its upward position the (upper) guide shoe 5 is in its lower position in FIG. 6.

The upright 3 has two slots 6. The (upper) guide shoe 5 is connected through these slots 6 via connecting members 7 with a counter plate 8.

Connected to the (upper) guide shoe 5, or more precisely to the counter plate 8, a displacement means 9 is provided. This displacement means 9 comprises a spring 10, namely a coil spring, configured as compression spring. One end of the spring 10 is connected to a lug 11 on the upright 3.

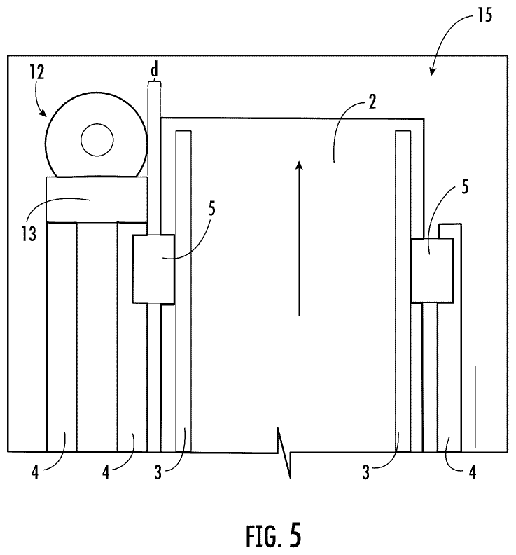

As can best be seen in FIGS. 2 and 5, the elevator system 1 also comprises a machine 12 on a machine bedplate 13. The distance d between the electrical machine 12 and/or the machine bedplate 13 on the one side and the elevator car 2 on the other side can be minimized, i.e. from about 75 mm to about 45 mm.

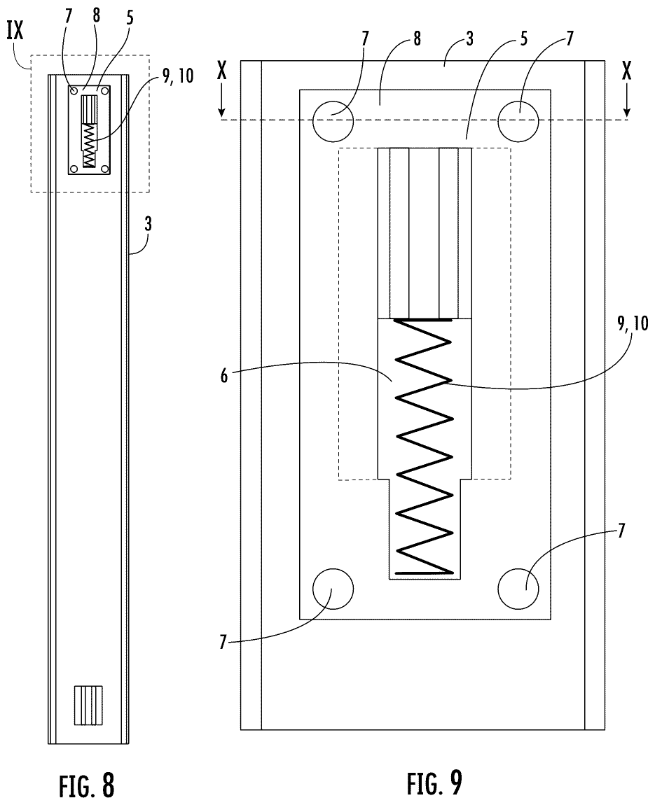

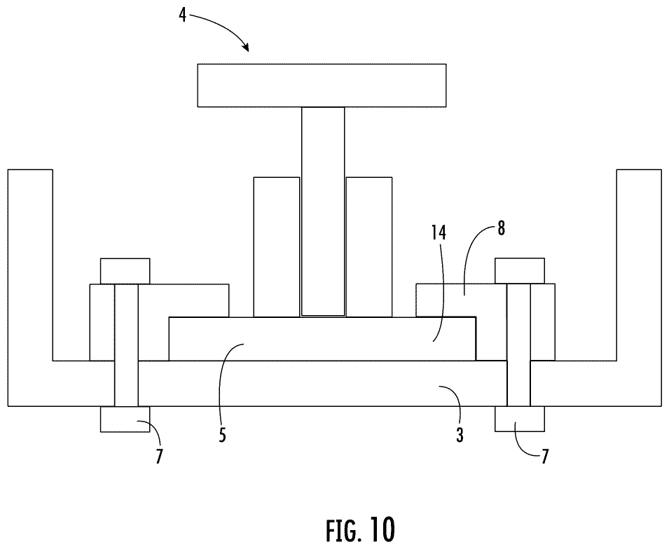

A different embodiment is depicted in the FIGS. 8 to 10. The counter plate 8 is fixed unmovably to the upright 3. The (upper) guide shoe 5 is engaging a projection of the counter plate 8 to be movable between two extreme positions, namely the upper position and the lower position.

### REFERENCE NUMBERS

1 elevator system
2 elevator car
3 upright
4 guide rail
5 (upper) guide shoe
6 slot
6a roof
7 connecting member
7a landing control panel
7b elevator car control panel
8 counter plate
9 displacement means
10 spring
11 lug
12 electrical machine
13 machine bedplate
14 protrusion
15 hoistway
16 landing
17 tension member
18 elevator drive system
19 motor
20 shaft
21 drive
22 elevator brake
23 counterweight
24 counterweight guide rail
25 landing door
26 car door
27 elevator controller
28 machine room
LD longitudinal direction
d distance

What is claimed is:

1. Elevator system (1) comprising at least one upright (3), with a guide shoe (5) being attached to the upright (3) for guiding of movement of an elevator car (2) along a guide rail (4), wherein the guide shoe (5) is slideably connected to the upright (3) between an upper position and a lower position, whereby the guide shoe (5) is in the upper position when the elevator car (2) is in a first reduced travel length mode and whereby the guide shoe (5) is in the lower position when the elevator car (2) is in a second enlarged travel length mode, whereas a displacement means (9) is attached to the guide shoe (5) for forcing the guide shoe (5) into the upper position.

2. Elevator system (1) according to claim 1, wherein the displacement means (9) comprises a spring (10), whereas the spring (10) is connected to the upright (3) and to the guide shoe (5) or a counter plate (8) connected to the guide shoe (5), or in that the displacement means (9) comprises a weight and a pulley system attached to the guide shoe (5) or the counter plate (8).

3. Elevator system (1) according to claim 2, wherein the spring (10) is a compression spring or a pull spring, preferably a coil spring.

4. Elevator system (1) according to claim 1, wherein the guide shoe (5) is movably positioned in one or preferably a plurality of slots (6), defining the upper position and the lower position for the guide shoe (5).

5. Elevator system (1) according to claim 4, wherein on one side of the upright (3) the guide shoe (5) is positioned, whereas the counter plate (8) is positioned on the other/opposing side of the upright (3) and connected via connecting members (7) extending through the slot (6) to the guide shoe (5).

6. Elevator system (1) according to claim 1, wherein at least one guide rail (4) being in guiding contact with at least one or better more guide shoes (5), for guiding the movement of the elevator car (2) during up- and/or down-mode-of-operation.

7. Elevator system (1) according to claim 6, wherein an electric machine (12) for hoisting the elevator car (2) up or down.

8. Elevator system (1) according to claim 7, wherein the electric machine (12) is connected to the one guide rail (4) or more guide rails (4) and/or positioned upwards of the top end of the guide rails (4).

9. Elevator system (1) according to claim 1, wherein the elevator car (2) comprises a car frame to which at least two uprights (3) are fixed.

10. Elevator system (1) according to claim 1, wherein the spring (10) is connected at one end to a lug (11) of the upright (3).
